(19) United States
(12) Patent Application Publication
(10) Pub. No.: US 2010/0275166 A1
(43) Pub. Date: Oct. 28, 2010

(54) USER ADAPTIVE GESTURE RECOGNITION METHOD AND USER ADAPTIVE GESTURE RECOGNITION SYSTEM

(75) Inventors: Jong Hong Jeon, Daejeon (KR); Seung Yun Lee, Daejeon (KR); Sung Han Kim, Daejeon (KR); Kang Chan Lee, Daejeon (KR)

Correspondence Address: Jae Y. Park, Kile, Park, Reed & McManus, PLLC, 1200 New Hampshire Ave. NW, Suite 570, Washington, DC, 20036, US

(73) Assignee: Electronics and Telecommunications Research Institute

(21) Appl. No.: 12/745,800

(22) PCT Filed: Aug. 29, 2008
(86) PCT No.: PCT/KR08/05100

§ 371 Date: Jun. 2, 2010

(30) Foreign Application Priority Data
Dec. 3, 2007 (KR) 10-2007-0124592
Mar. 10, 2008 (KR) 10-2008-0022182

(51) Int. Cl. G06F 3/033

(52) U.S. Cl. 715/863

(57) ABSTRACT

The present invention relates to a user adaptive gesture recognition method and a user adaptive gesture recognition system. The present invention relates to a user adaptive gesture recognition method and a user adaptive gesture recognition system that, by using a terminal equipped with an acceleration sensor, can drive mobile application software in the terminal or can process a function of an application program for browsing to be displayed on the terminal based on acceleration information. Accordingly, the user gesture can be recognized and processed by using an acceleration sensor installed in a mobile apparatus. In addition, the user adaptive gesture can be stored in the mobile apparatus by using the acceleration sensor, and thus a mobile application can be easily utilized with a simple gesture.

### TECHNICAL FIELD

The present invention relates to a user adaptive gesture recognition method and a user adaptive gesture recognition system.

The present invention was supported by the IT R&D program of MIC/IITA [2007-P10-21, Development of Mobile OK Standard for Next-Generation Web Application].

### BACKGROUND ART

Many users are using many mobile digital apparatuses. The mobile digital apparatuses include a cellular phone, a PDA (personal digital assistant), a PMP (portable multimedia player), an MP3P (moving picture experts group audio layer-3 player), a digital camera, and the like.

Such mobile apparatuses provide a user interface by means of a button having a directional key function or a keypad. In recent years, a touch screen has been widely used, and thus an interface is provided in various ways. Such a mobile apparatus has a display device for information display and an input unit for input operation in a compact terminal. Accordingly, unlike a personal computer, in the mobile apparatus it is difficult to use a user interface such as a mouse. This causes the user to feel inconvenience in an environment in which the movements among the screens are complex, for example in a mobile browsing environment.

In addition, the user who uses the mobile apparatus wants to use mobile applications including browsing with one hand. However, in a button-type mobile apparatus using a keypad, the user needs to press many buttons for screen movement. In addition, when a touch pad is used, the user needs to use both hands.

Accordingly, in the mobile apparatus, a method of providing an effective interface to a user is important to revitalize mobile browsing and applications. Therefore, there is a need for development of a new technology to revitalize mobile browsing and applications.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a user adaptive gesture recognition system and a user adaptive gesture recognition method using a mobile apparatus equipped with an acceleration sensor, having an advantage of recognizing and storing a user gesture.

### Technical Solution

An exemplary embodiment of the present invention provides a user adaptive gesture recognition system that recognizes based on information collected by a terminal equipped with a sensor. The system includes: a sensing information processing unit that extracts a coordinate value from sensing information collected by the sensor; a user adaptive gesture processing unit that extracts position conversion information from the extracted coordinate value to recognize a user gesture, and outputs association information for driving one of a browser function and application program functions in association with the user gesture or stores the user gesture; and an association unit that associates an interface with the user gesture based on the output association information.

Another embodiment of the present invention provides a user adaptive gesture recognition method that recognizes a user gesture based on information collected by a terminal equipped with a sensor. The method includes: extracting a coordinate value from sensing information collected by the sensor; extracting position conversion information from the extracted coordinate value, and recognizing a user gesture based on the extracted position conversion information; determining whether or not interface information corresponding to the recognized user gesture is stored; and if it is determined in the determining that the interface information corresponding to the user gesture is stored, generating interface information for associating the corresponding interface with the gesture and associating the interface with the gesture.

Yet another embodiment of the present invention provides a user adaptive gesture recognition method that recognizes a user gesture based on information collected by a terminal equipped with a sensor.

The method includes: determining whether or not a gesture registration request is input; when the gesture registration request is input, extracting a coordinate value from sensing information collected by the sensor; extracting position conversion information from the extracted coordinate value, and recognizing a user gesture based on the extracted position conversion information; determining whether or not standard gesture information corresponding to the recognized user gesture is stored; and if it is determined that the standard gesture information is not stored, defining and storing a command of the user gesture and interface information corresponding to the user gesture.

### ADVANTAGEOUS EFFECTS

Therefore, the user gesture can be recognized and processed by using the acceleration sensor in the mobile apparatus.

In addition, the user adaptive gesture can be stored in the mobile apparatus by using the acceleration sensor, and thus the mobile application can be utilized with a simple gesture.

Furthermore, the present invention can be applied to various mobile apparatuses, thereby improving the user interface of the mobile apparatus.

### DESCRIPTION OF DRAWINGS

FIG. 1 is a diagram illustrating the principle of general acceleration sensors.

FIG. 2 is a diagram illustrating the detection principle of a general acceleration sensor.

FIG. 3 is a diagram illustrating a keypad-type terminal equipped with an acceleration sensor according to an exemplary embodiment of the present invention.

FIG. 4 is a diagram illustrating a touch screen-type terminal equipped with an acceleration sensor according to an exemplary embodiment of the present invention.

FIG. 5 is a diagram illustrating the structure of a user adaptive gesture recognition system according to an exemplary embodiment of the present invention.

FIG. 6 is a diagram illustrating the detailed structure of a user adaptive gesture processing unit according to an exemplary embodiment of the present invention.

FIGS. 7 and 8 are diagrams illustrating user gestures according to an exemplary embodiment of the present invention.

FIG. 9 is a diagram illustrating user gesture patterns according to an exemplary embodiment of the present invention.

FIG. 10 is a flowchart illustrating a successive user gesture recognition processing according to an exemplary embodiment of the present invention.

FIG. 11 is a flowchart illustrating a user gesture registration processing according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements. The terms “-er”, “-or”, and “module” described in the specification mean units for processing at least one function and operation and can be implemented by hardware components or software components and combinations thereof.

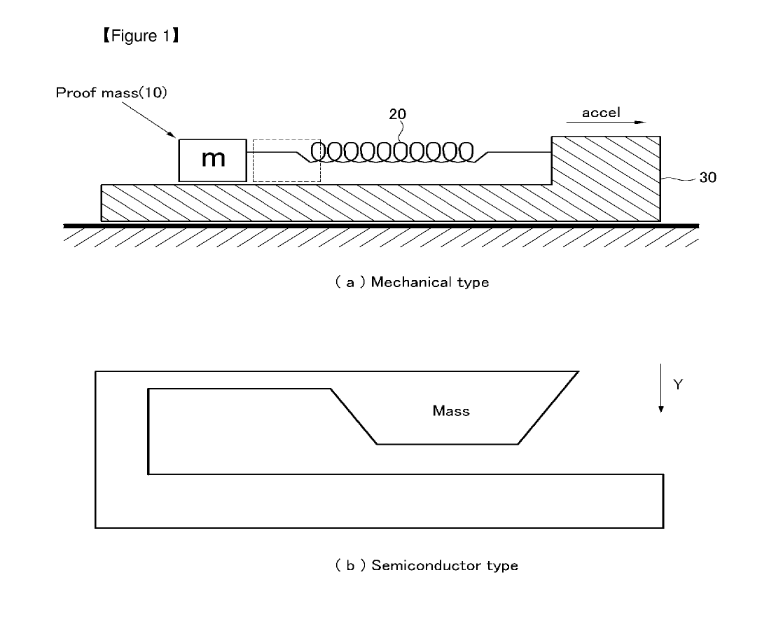

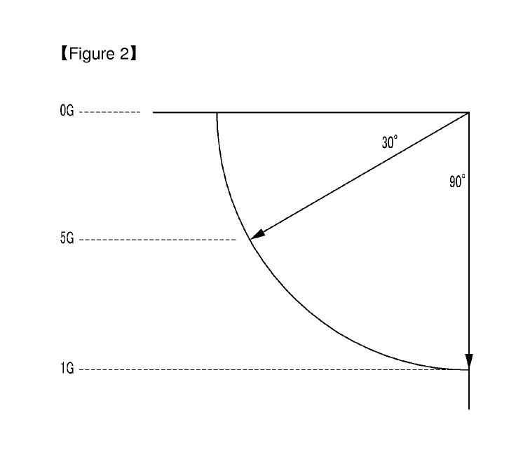

Prior to describing an exemplary embodiment of the present invention, the principle of a general acceleration sensor and the detection principle thereof will be described with reference to FIGS. 1 and 2.

FIG. 1 is a diagram illustrating the principle of general acceleration sensors.

As shown in (a) and (b) of FIG. 1, the acceleration sensor is generally used in an airbag of an automobile. Specifically, the acceleration sensor is used to instantaneously detect an impact when the automobile is crashed. The acceleration sensor is an element for detecting a change in speed per unit time. In the related art, a mechanical-type sensor was used, but at present, a semiconductor-type sensor is widely used. The semiconductor-type sensor can be small and perform accurate detection. The semiconductor-type sensor is installed in the mobile terminal to measure an inclination, thereby correcting screen display. In addition, the semiconductor-type sensor is used in a passometer to detect a shake during movement.

As shown in (a) of FIG. 1, the mechanical-type acceleration sensor primarily includes a proof mass 10, a spring 20, and a damper 30. The acceleration is calculated based on a change in position of the proof mass by Math Figure 1.

F=kx=ma [Math Figure 1]

From Math Figure 1, the equation

$$a = \frac{k}{m} x$$

is obtained. Here,

$${ω}_{0} is \sqrt{\frac{k}{m}} .$$

Since the mechanical-type acceleration sensor covers a small acceleration range, it is not suitable for a small and thin portable electronic apparatus. Accordingly, a semiconductor-type acceleration sensor having a proof mass shown in (b) of FIG. 1 is attracting attention.

The acceleration sensor put to practical use shown in (b) of FIG. 1 outputs the size of the acceleration applied to the object, and is divided according to the number of axes. For example, the acceleration sensor includes a one-axis acceleration sensor, a two-axis acceleration sensor, and a three-axis acceleration sensor. The three-axis acceleration sensor that has a detection range in three directions can measure the acceleration in a three-dimensional space in three directions of x, y, and z axes. The three-axis acceleration sensor is used to detect the inclination of the terminal. Other acceleration sensors are used in the airbag of the automobile and to control a walking posture of a robot and to detect a shock in an elevator.

Next, the detection principle of the general acceleration sensor will be described with reference to FIG. 2.

FIG. 2 is a diagram illustrating the detection principle of a general acceleration sensor.

As shown in FIG. 2, when the acceleration sensor that is placed along the horizontal direction is inclined and then placed at right angles with respect to gravity, that is, along the vertical direction, acceleration of gravity of 1 G is detected. Accordingly, the acceleration of gravity based on the inclination may be as shown in FIG. 2. For example, if the acceleration of gravity is 0.5 G, the gradient (sine value) is 30°.

That is, if the acceleration in the x-axis direction is 0 G and the acceleration in the y-axis direction is 1 G, the sensor is vertical along the y-axis direction. Meanwhile, if the acceleration in the x-axis direction is 1 G, and the acceleration in the y-axis direction is 0 G, the sensor is placed along the x-axis direction. When the acceleration sensor is inclined at 45° in the x-axis direction, the acceleration is calculated by the equation 1 G×Sin 45, that is, 0.707 G. In this way, the inclination state of the sensor versus the ground direction can be detected.

The detection sensitivity [V/g] of the acceleration sensor represents a decrease in acceleration detection due to a change in voltage per acceleration. The larger the detection sensitivity is, the better the acceleration sensor is. For application to the portable electronic apparatus, an acceleration sensor needs to be small and thin, and should have excellent detection sensitivity and impact resistance.

The acceleration sensors may be divided into a piezo-resistive type, a capacitive type, a heat distribution detection type, and a magnetic type according to an acceleration detection method. In the portable electronic apparatus, since a low acceleration of gravity needs to be detected, the piezo-resistive type and the capacitive type are attracting attention.

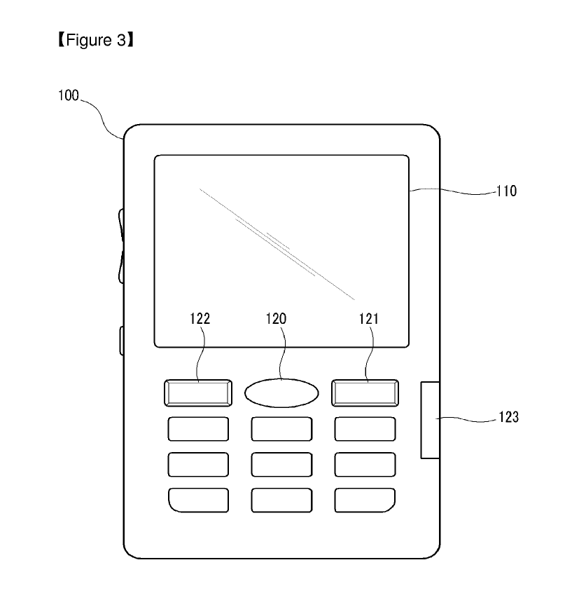

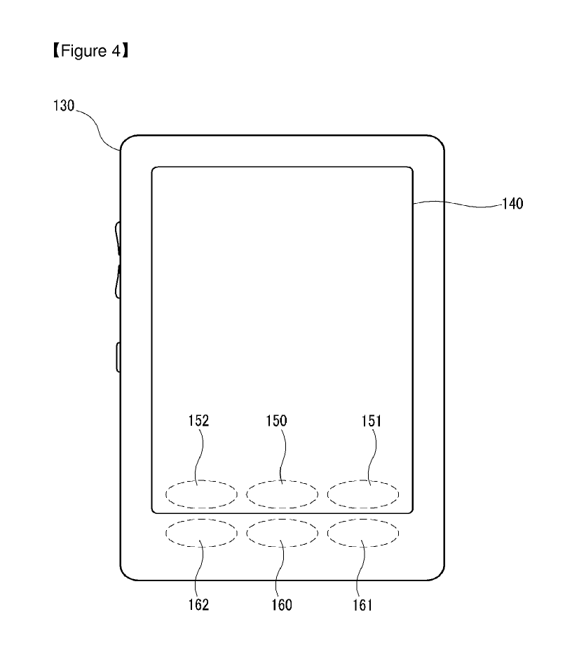

Next, a method of processing an interface system for browsing in association with main functions in a terminal based on acceleration information generated by a users hand operation by using a terminal equipped with the above-described acceleration sensor will be described. First, a terminal equipped with an acceleration sensor will be described with reference to FIGS. 3 and 4.

FIG. 3 is a diagram illustrating a keypad-type terminal equipped with an acceleration sensor according to an exemplary embodiment of the present invention.

As shown in FIG. 3, a terminal 100 according to an exemplary embodiment of the present invention includes a keypad or buttons. A user gesture is recognized by an acceleration sensor installed in the terminal. That is, when the terminal 100 executes mobile browsing or a mobile application, the mobile application or the contents of mobile browsing is displayed on a display unit 110 of the terminal 100. Here, user gesture recognition by the acceleration sensor installed in the terminal 100 may be made as follows.

First, user gesture recognition may be based on single recognition. In this case, when the user wants to input his/her gesture to the terminal, he/she inputs a gesture while pressing a button assigned with a recognition request function, and then releases the button. In this way, a gesture is input. At this time, the gesture input may be achieved by buttons 120 to 123 according to the characteristics of the terminal. Alternatively, the gesture input may be achieved by a function unique to each button. According to such user gesture recognition, in a state where the user gesture is pre-stored in the terminal, when the user performs a specific gesture, an interface or a program corresponding to the specific gesture is executed.

In addition, user gesture recognition may be based on successive recognition. In this case, the user presses one of buttons 120 to 123 assigned with a successive recognition request function to drive a successive gesture recognition function, such that the user gestures are successively recognized.

Finally, the user may register a gesture in advance and use the gesture. In this case, the user inputs a user gesture to be registered while pressing one of buttons 120 to 123 assigned with a user gesture registration request function, and then releases the button. In this way, the user gesture to be registered is input. Subsequently, user gesture registration is performed.

Next, a touch screen-type terminal having no keypad or buttons will be described with reference to FIG. 4.

FIG. 4 is a diagram illustrating a touch screen-type terminal equipped with an acceleration sensor according to an exemplary embodiment of the present invention.

A terminal shown in FIG. 4 includes a touch panel but performs gesture recognition based on an internal acceleration sensor, and operates similarly to the terminal having a keypad or buttons shown in FIG. 3. However, since the terminal shown in FIG. 4 includes a touch panel, gesture recognition is made differently from that of the terminal shown in FIG. 3.

A terminal equipped with a touch screen 140 according to an exemplary embodiment of the present invention assigns predetermined regions of the touch screen to virtual buttons 150 to 152 in advance. The assigned regions function as a successive recognition processing function call virtual button 150, a single recognition processing function call virtual button 151, and a user gesture recognition call virtual button 152. Even if a terminal includes a touch screen, one or more buttons 160 to 162 are separately provided, the functions may be assigned to the buttons, like the terminal having a keypad or buttons.

Next, a user adaptive gesture recognition system that receives sensing information from an acceleration sensor in a terminal according to an exemplary embodiment of the present invention, and recognizes and processes a user gesture, will be described with reference to FIG. 5. In this embodiment, a user adaptive gesture recognition system 200 is installed in the terminal, but this is not intended to limit the present invention.

FIG. 5 is a diagram illustrating the structure of a user adaptive gesture recognition system according to an exemplary embodiment of the present invention.

As shown in FIG. 5, a user adaptive gesture recognition system includes a button recognition unit 210, a sensing information processing unit 220, a user adaptive gesture processing unit 230, and an association unit 240. The association unit 240 includes an in-terminal function association unit 241, a mobile browser association unit 242, and a mobile application association unit 243.

The button recognition unit 210 recognizes a user gesture or determines to register the user gesture when the user presses a button assigned with a user gesture recognition request function, a button assigned with a user gesture registration request function, or a corresponding region of the touch screen.

The sensing information processing unit 220 receives sensing information from the terminal 100 at the same time the button recognition unit 210 recognizes the operation of the button, and extracts a coordinate value collected by the acceleration sensor. Here, a method of extracting a coordinate value is well known in the art, and herein a detailed description thereof will be omitted.

The user adaptive gesture processing unit 230 recognizes the user gesture based on the coordinate value extracted by the sensing information processing unit 220. Then, the user adaptive gesture processing unit 230 searches an interface or program driving information that is pre-registered by the user in association with the recognized gesture, and drives an in-terminal function, a mobile browser function, or a function of a mobile application program in association with the interface or program.

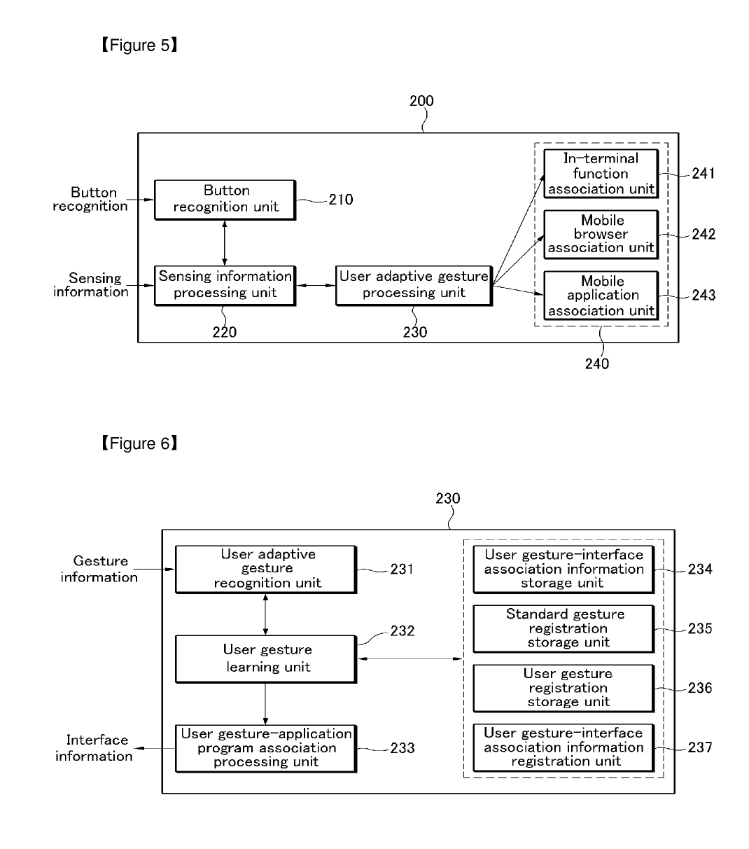

The user adaptive gesture processing unit 230 will be described in detail with reference to FIG. 6.

FIG. 6 is a diagram illustrating the detailed structure of the user adaptive gesture processing unit according to an exemplary embodiment of the present invention.

As shown in FIG. 6, the user adaptive gesture processing unit 230 includes a user gesture learning unit 232, a user adaptive gesture recognition unit 231, a user gesture-application program association processing unit 233, and an information storage unit. The information storage unit includes a user gesture-interface association information storage unit 234, a user gesture-interface association information registration unit 237, a standard gesture registration storage unit 235, and a user gesture registration storage unit 236.

The user adaptive gesture recognition unit 231 recognizes the user gesture based on a coordinate value extracted from the sensing information.

The user gesture learning unit 232 records the user gesture recognized by the user adaptive gesture recognition unit 231, searches interface association information corresponding to the user gesture, and determines whether or not to register the user gesture. Here, the recording of the user gesture means that the user gesture recognized by the user adaptive gesture recognition unit 231 is temporarily recorded prior to storing the user gesture in each storage unit according to the situation.

The user gesture-application program association processing unit 233 receives user gesture information from the user gesture learning unit 232 and outputs application program information for driving a program or an interface corresponding to the user gesture information. That is, the user gesture-application program association processing unit 233 searches association information about the application program or interface stored in the user gesture-interface association information storage unit 237, and if program or interface information corresponding to the user gesture information is stored, outputs the application program information through the interface so as to drive the program or interface. If the program or interface information corresponding to the user gesture information is not stored, the user-gesture-application program association processing unit 233 performs control to store the user gesture information.

The user gesture-interface association information storage unit 234 stores, in association with the user gesture information, association information on the application program or interface when the user performs the corresponding gesture.

The user gesture-interface association information registration unit 237 registers the program or interface information on the user gesture. The registration information includes the program or interface information in the user gesture-interface association information storage unit 234. That is, while the user gesture-interface association information storage unit 234 stores the program or interface information that is pre-set by the user, the user gesture-interface association information registration unit 237 stores information on programs or interfaces that can be executed on the terminal.

The standard gesture registration storage unit 235 stores feature values of individual standard gestures for user gesture recognition. The standard gesture-based feature value is information on a predefined gesture. Accordingly, even if the user does not input information on a user adaptive gesture, a service can be provided with a gesture that is pre-stored in the standard gesture registration storage unit 235.

The user gesture registration storage unit 236 stores feature values of individual user gestures. The user gesture-based feature value is stored in association with the program or interface information stored in the user gesture-interface association information storage unit 234. In this embodiment, the user gesture registration storage unit 236 and the user gesture-interface association information storage unit 234 are provided separately from each other, but this is not intended to limit the present invention.

The association unit 240 shown in FIG. 5 includes the in-terminal function association unit 241 that performs association with various functions in the terminal, the mobile browser association unit 242 that performs association with a mobile browser, and the mobile application association unit 243 that performs association with a mobile application. The association unit 240 performs association with one of a function in the terminal, a mobile browser, and a mobile application according to the user gesture.

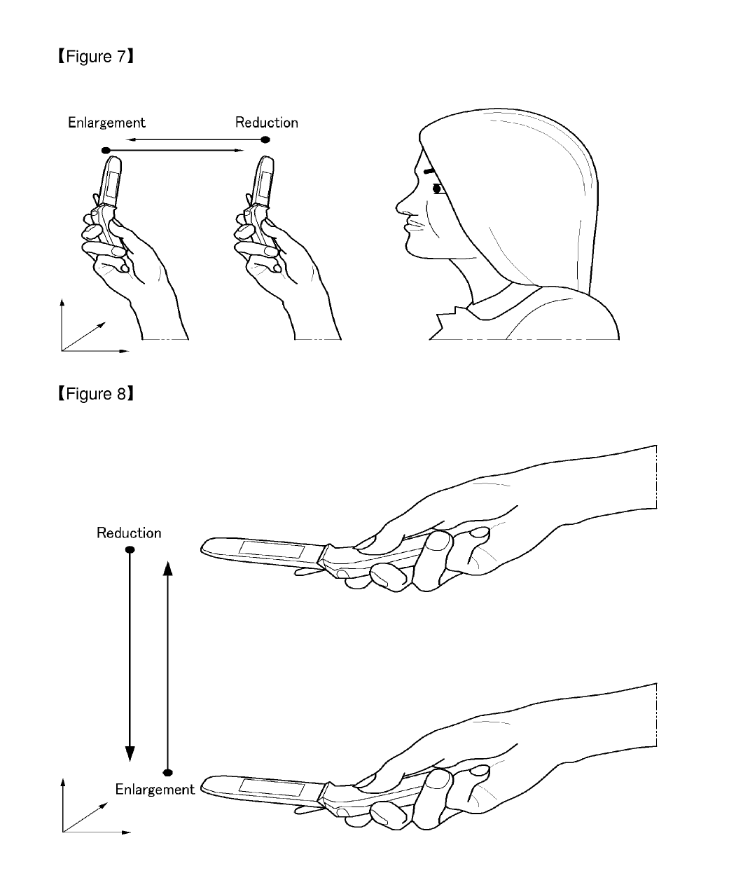

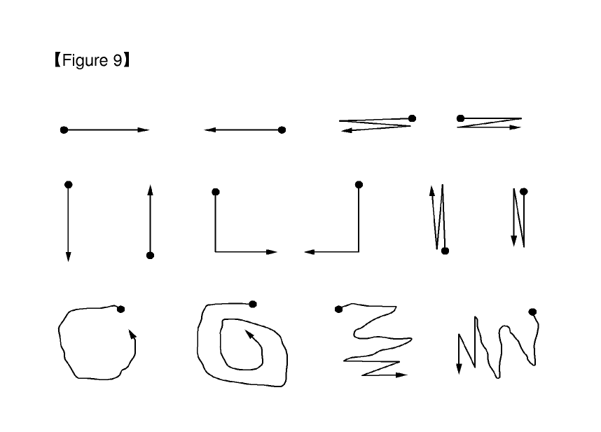

Next, an example of user gesture recognition will be described with reference to FIGS. 7 and 8.

FIGS. 7 and 8 are diagrams illustrating user gestures according to an exemplary embodiment of the present invention.

As shown in FIG. 7, the user may perform a gesture with the terminal while pressing a button for gesture recognition motion, or may perform an enlargement gesture or a reduction gesture that are pre-registered so as to enlarge or reduce the size of the display screen. The gesture that is stored in the user gesture registration storage unit 236 is based on the sensing information collected by the acceleration sensor in a state where the user presses a button for successive motion recognition. FIG. 7 illustrates an example where the screen size is enlarged or reduced when the terminal is moved forth or back.

If the terminal includes a touch screen, the user may touch a virtual button so as to execute the same function.

As another example of user adaptive gesture recognition, FIG. 8 illustrates a gesture on up and down motion in a three-dimensional space. In FIG. 8, it is assumed that the screen is reduced or enlarged when the terminal is moved up or down.

If the user executes a reduction gesture or an enlargement gesture with the terminal while pressing a button for gesture recognition or a button for successive motion recognition, an interface function to reduce or enlarge the display screen size is executed. When the terminal includes a touch screen, the user may touch a virtual button so as to execute the same function.

Various patterns of the user gestures to be input by the user with an acceleration sensor according to an exemplary embodiment of the present invention will be described with reference to FIG. 9.

FIG. 9 is a diagram illustrating user gesture patterns according to an exemplary embodiment of the present invention.

As shown in FIG. 9, various patterns may be performed according to a three-dimensional direction from a start point to an end point, a kind of a turn, and a rotation direction. In addition to the gesture patterns shown in FIG. 9, other different gesture patterns may be defined by the user. The defined gesture patterns are used in association with related programs.

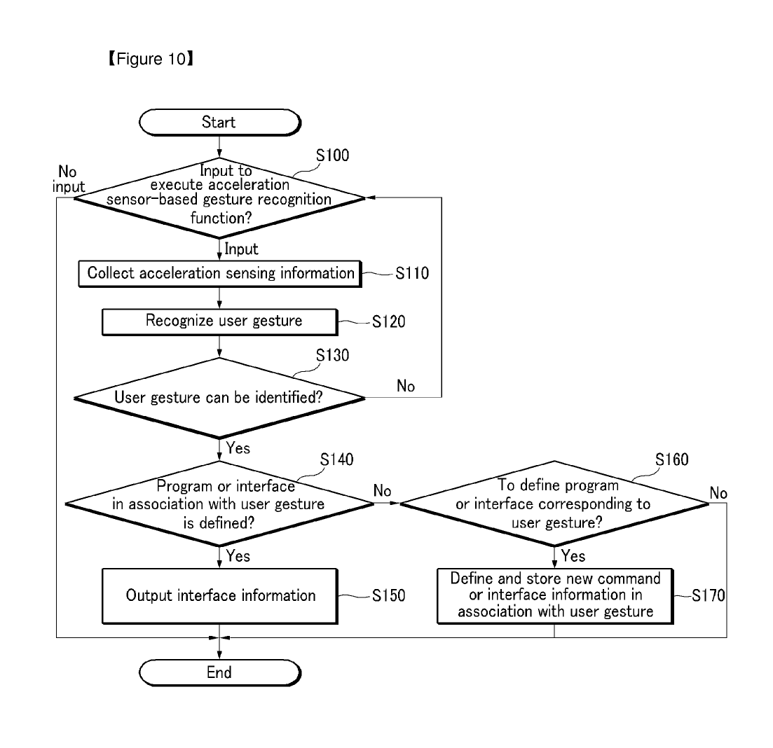

A processing for receiving sensing information and recognizing a gesture by using a terminal equipped with an acceleration sensor will be described with reference to FIG. 10.

FIG. 10 is a flowchart a successive user gesture recognition processing according to an exemplary embodiment of the present invention.

As shown in FIG. 10, the button recognition unit 210 of the terminal determined whether or not an input to execute an acceleration sensor-based gesture recognition function is received (S100). Here, the user presses an acceleration sensor-based gesture recognition start button and generates an input signal so as to perform the input to execute the acceleration sensor-based gesture recognition function, but this is not intended to limit the present invention.

If the button recognition unit 210 determines that the user performs the input to execute the acceleration sensor-based gesture recognition function, the sensing information processing unit 220 collects acceleration sensing information (S110). Here, the collected acceleration sensing information means a coordinate value of the acceleration sensor when being moved.

Next, the user adaptive gesture recognition unit 231 of the user adaptive gesture processing unit 230 receives the acceleration sensing information as the coordinate value from the sensing information processing unit 220, and extracts successive three-dimensional position conversion information. In addition, the user adaptive gesture recognition unit 231 recognizes a user gesture from the extracted position conversion information (S120), and transmits the user gesture to the user gesture learning unit 232. The user gesture learning unit 232 records the user gesture based on the acceleration sensing information, and then determines whether or not the recorded user gesture is stored in and can be identified from the user gesture registration storage unit 236 (S130). That is, the user gesture learning unit 232 determines whether or not the gesture recognized based on the sensing information is stored in and can be identified from the user gesture registration storage unit 236 (S130).

If the user gesture learning unit 232 determines that the gesture recognized based on the acceleration sensing information can be identified, it is confirmed whether or not a program or an interface is predefined in association with the corresponding gesture (S140). Whether or not the program or interface in association with the gesture is predefined is determined according to whether or not the corresponding program or interface is searched from the user gesture-interface association information storage unit 234. If the program or interface is predefined, interface information is output for association with the corresponding program or interface (S150).

If it is determined in step S140 that no program or interface in association with the gesture is defined in the user gesture-interface association information storage unit 234, it is determined whether or not to define a new program or interface in association with the corresponding gesture (S160). If it is determined to define the program or interface, the user gesture learning unit 232 transmits information on the program or interface in association with the corresponding gesture to the user gesture-interface association information registration unit 237 and stores the program or interface program therein (S170).

If it is determined in step S130 that the gesture cannot be identified, recognition of the corresponding gesture is interrupted, and the process returns to step S100 in which it is determined whether or not an input to execute a gesture recognition function is received.

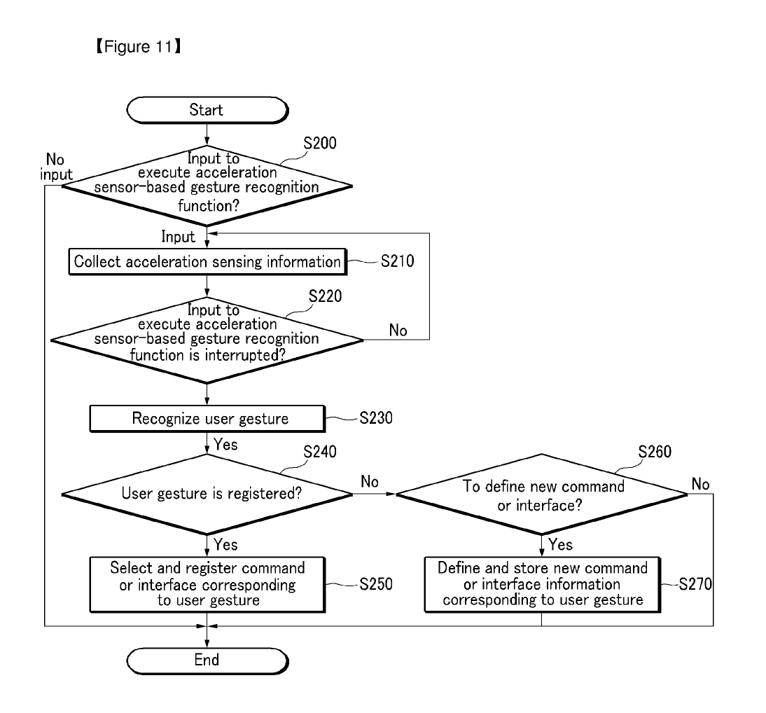

Next, a process for receiving a user gesture as sensing information and registering the received user gesture as a new gesture by using a terminal equipped with an acceleration sensor according to an exemplary embodiment of the present invention will be described with reference to FIG. 11.

FIG. 11 is a flowchart illustrating user gesture registration processing according to an exemplary embodiment of the present invention.

As shown in FIG. 11, the button recognition unit 210 determines whether or not the user presses an acceleration sensor-based gesture registration button to perform an input to execute a gesture registration function (S200). If the user presses the button and requests gesture registration, the sensing information processing unit 220 collects acceleration sensing information from the acceleration sensor (S210).

Subsequently, the button recognition unit 210 determines whether or not the user releases the acceleration sensor-based gesture registration button to interrupt the registration request input (S220). If the registration request input is not received, the button recognition unit 210 recognizes a gesture from the acceleration sensing information received by the user adaptive gesture recognition unit 231 (S230). The user gesture learning unit 232 determines whether or not the gesture recognized by the user adaptive gesture recognition unit 231 is pre-registered in the user gesture registration storage unit 236 (S240). If it is determined that the recognized gesture is not registered, the user gesture learning unit 232 selects a command or interface in association with the gesture, and registers the selected command or interface in the user gesture registration storage unit 236 (S250).

If it is determined in step S240 that the recognized gesture has already been registered, the user gesture learning unit 232 determines whether or not to define a new command or interface (S260). It the user gesture learning unit 232 determines to define a new command or interface, the new command or interface information is selected from the standard gesture registration storage unit 235 or the user gesture-interface association information registration unit 237, and is then input to and stored in the user gesture-interface association information storage unit 234 (S270).

The embodiment of the present invention described above is not implemented by only the method and apparatus, but it may be implemented by a program for executing the functions corresponding to the configuration of the exemplary embodiment of the present invention or a recording medium having recorded thereon the program. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A user adaptive gesture recognition system that recognizes a user gesture based on information collected by a terminal equipped with a sensor, the system comprising:
a sensing information processing unit that extracts a coordinate value from sensing information collected by the sensor;
a user adaptive gesture processing unit that extracts position conversion information from the extracted coordinate value to recognize a user gesture, and outputs association information for driving one of a browser function and application program functions in association with the user gesture or stores the user gesture; and
an association unit that associates an interface with the user gesture based on the output association information.

2. The system of claim 1, further comprising
a button recognition unit that, when the user presses one of a button assigned with a user gesture recognition request function and a button assigned with a user gesture registration request function, confirms recognition of the corresponding button.

3. The system of claim 2, wherein the button recognition unit confirms the recognition of the corresponding button when the user touches a touch screen-based virtual button.

4. The system of claim 2, wherein the association unit includes:
an in-terminal function association unit that performs association with a function in the terminal;
a mobile browser association unit that performs association with a browser; and
a mobile application association unit that performs association with a mobile application.

5. The system of claim 1, wherein the user adaptive gesture processing unit includes:
a user adaptive gesture recognition unit that recognizes the user gesture from the position conversion information;
a user gesture learning unit that searches interface association information corresponding to the user gesture, and determines whether or not to register the user gesture;
a user gesture-application program association processing unit that generates interface information corresponding to the user gesture, and outputs the interface information for association by the association unit; and
an information storage unit that stores information on the user gesture, the interface association information corresponding to the user gesture, and pre-defined standard gesture information.

6. The system of claim 5, wherein the information storage unit includes:
a user gesture-interface association information registration unit that stores the interface association information corresponding to the user gesture and basic interface information provided from the terminal;
a user gesture registration storage unit that stores the user gesture recognized by the user adaptive gesture recognition unit;
a user gesture-interface association information storage unit that stores the interface association information corresponding to the user gesture stored in the user gesture registration storage unit; and
a standard gesture registration storage unit that stores, in addition to the user adaptive gesture stored by the user, pre-defined standard gestures.

7. The system of claim 1, wherein the sensor is an acceleration sensor.

8. A user adaptive gesture recognition method that recognizes a user gesture based on information collected by a terminal equipped with a sensor, the method comprising:
extracting a coordinate value from sensing information collected by the sensor;
extracting position conversion information from the extracted coordinate value, and recognizing a user gesture based on the extracted position conversion information;
determining whether or not interface information corresponding to the recognized user gesture is stored; and
if it is determined in the determining that the interface information corresponding to the user gesture is stored, generating interface information for associating the corresponding interface with the gesture and associating the interface with the gesture.

9. The method of claim 8, further comprising, if it is determined that the interface information corresponding to the user gesture is not stored:
confirming whether or not to define interface information corresponding to the user gesture; and
if it is confirmed to define the interface information, associating the user gesture with one of an in-terminal function, a mobile browser, and a mobile application.

10. The method of claim 8, further comprising, before the extracting of the coordinate value,
determining whether or not an input for gesture recognition is received.

11. A user adaptive gesture recognition method that recognizes a user gesture based on information collected by a terminal equipped with a sensor, the method comprising:
determining whether or not a gesture registration request is input;
when the gesture registration request is input, extracting a coordinate value from sensing information collected by the sensor;
extracting position conversion information from the extracted coordinate value, and recognizing a user gesture based on the extracted position conversion information;
determining whether or not standard gesture information corresponding to the recognized user gesture is stored; and
if it is determined that the standard gesture information is not stored, defining and storing a command of the user gesture and interface information corresponding to the user gesture.

12. The method of claim 11, wherein the extracting of the coordinate value includes:
determining whether or not the input for the registration request is interrupted; and
extracting a coordinate value from when the registration request is input until the input is interrupted.

13. The method of claim 12, further comprising, if it is determined that the standard gesture information is stored:
determining whether or not to define the interface information corresponding to the user gesture as new interface information; and
if it is determined to define the interface information as the new interface information, defining and storing the interface information as the new interface information.
